(19) United States
(12) Patent Application Publication
(10) Pub. No.: US 2007/0200717 A1
(43) Pub. Date: Aug. 30, 2007

(54) Thermohygrometer for windows

(76) Inventor: Robert Michaud, St-Jean-Chrysostome (CA)

Correspondence Address: Eric Fincham, 316 Knowlton Road, Lac Brome, QC, J0E 1V0, CA

(21) Appl. No.: 11/702,447

(22) Filed: Feb. 5, 2007

(30) Foreign Application Priority Data
Feb. 6, 2006 (CA) 2,535,266

(51) Int. Cl. G01W 1/00; G08B 1/08

(52) U.S. Cl. 340/601; 340/539.1

(57) ABSTRACT

A meteorological display system comprising at least one sensor mounted exteriorly of a building to sense at least one meteorological condition, a transmitter associated with the sensor, the transmitter having a circuit to transmit a signal representing the value measured by the sensor, a first display unit mounted interiorly of the building, the display unit having a circuit for receiving the signal and displaying an indicia reflecting the at least one meteorological condition, a repeater transmitter associated with the first display for sending a repeater signal to a second display unit. In one embodiment, the display unit is designed to sense and display and interior temperature, the interior temperature being modified to account for thermal loss due to location of the display unit.

### FIELD OF THE INVENTION

The present invention relates to windows and more particularly, relates to meteorological data displayed on a window.

### BACKGROUND OF THE INVENTION

It is well acknowledged that the weather is of substantial interest to most people. Thus, many casual conversations and introductions relate to the weather, either at the present, or in the past or future. The interest in the weather for most people is evidenced by the fact that there are television and radio stations devoted solely to-the weather.

As a very minimum, most people want to know what the current conditions are and also conditions for the immediate future. This is self evident by the number of thermometers and hygrometers present in many residences.

Typically, in a residence a conventional thermometer is attached to an exterior frame member of a window. While this was readily accepted when window frames were primarily wood, the increasing use of various plastics and metals, along with the desire to leave the window frame unmarred, has led to a decline in the use of such thermometers. As a replacement therefore, the use of wireless technology with sensors placed outside the window has increasingly been utilized. However, even this technology can present problems if the distances are greater than the capability of the wireless sensor sending information to the receptor.

A still further problem with the use of such instruments is that they typically display the interior temperature. When the display is placed proximate the interior of a window, the accuracy is substantially diminished as the temperature reading, particularly in colder climates, can be several degrees below the actual temperature elsewhere in the room.

### SUMMARY OF THE INVENTION

It is an object of the present invention to provide a system for the display of meteorological conditions, which system is designed to be used near a window and which overcomes the aforementioned problems with prior art systems.

According to one aspect of the present invention, there is provided a meteorological display system for a building comprising at least one sensor designed to be mounted exteriorly of the building to sense at least one meteorological condition, a transmitter designed to be mounted proximate the sensor, the transmitter having a circuit to transmit a signal of a value measured by the at least one sensor, a first display unit for mounting interiorly of the building, window, the first display unit having a circuit for receiving the signal and displaying an indicia reflecting the at least one meteorological condition, a repeater transmitter associated with the first display unit for sending a repeater signal corresponding to the signal from the transmitter, a second display unit, the second display unit having a circuit for receiving the repeater signal and displaying an indicia reflecting the at least one meteorological condition from said repeater signal.

According to a further aspect of the present invention there is provided a meteorological display system for use with a window comprising at least one sensor designed to be mounted exteriorly of the window to sense an exterior temperature, a transmitter associated with the sensor to send a signal corresponding to a value sensed by the at least one sensor, a display unit for mounting on the window, the display unit having a sensor for sensing an interior temperature, a receiving circuit for receiving the signal from the exterior sensor, signal modifying means for modifying the internal temperature signal to display an adjusted value.

According to a still further aspect of the present invention there is provided a method for displaying meteorological conditions comprising the steps of placing at least one sensor exterior of a building to sense at least one exterior meteorological condition, transmitting a signal corresponding to a value sensed by the sensor, placing a display unit interiorly of a building, the display unit having a circuit for receiving the signal and displaying an indicia reflecting the at least one meteorological condition, taking the signal received by the display unit and relaying the signal to at least one further display unit.

According to a still further aspect of the present invention there is provided a method for displaying meteorological conditions comprising the steps of sensing an exterior temperature with a sensor located exteriorly of a building, transmitting a signal reflective of the exterior temperature, placing a display unit on an interior side of a window, the display unit having an internal sensor to sense and display an interior temperature, and modifying the interior temperature according to the value of the exterior temperature.

In a first aspect of the present invention, there is provided at least a first sensor which is located exteriorly of the building. The sensor may be capable of monitoring one or more meteorological parameters and/or there may be provided a plurality of sensors, each one designed to monitor a single meteorological condition. Naturally, one of the prime parameters is the exterior temperature since this is a very common requirement. However, any number of other different meteorological conditions can be sensed including, for example, the outdoor humidity, wind speed, wind chill, dew point, barometric pressure, precipitation indicator, etc. It suffices to say that any meteorological condition which can be measured can be included within the scope of the present invention.

The sensor is arranged such that each measured parameter is converted to a value which can be sent by a transmitter to a receiving unit interiorly of the building. One may have a single unit which is capable of receiving input from all the sensors or alternatively, more than one transmitter may be utilized. It will be understood that such sensors and transmitters are well known in the art.

The system includes an interior display module, which display module is designed to receive a signal from one or more of the sensors and convert the signal to a displayed indicia. The indicia may comprise a numerical value (such as for temperature), letter values (such as for wind direction) and/or symbols and/or icons. Again, such display systems are known in the art and are commercially available.

In one embodiment of the invention, the display unit mounted interiorly of the building includes a repeater station, the repeater station being designed to take the signal from the exterior transmitter and retransmit the same to one or more slave display units within the building. This thus overcomes the problem of signals not being received by remote display units due to signal strength.

One or more slave units may be utilized depending upon the particular requirement. Each of the slave units also functions as a repeater station for retransmitting the information. The transmission of the information from the exterior sensor or sensors and from the repeater stations may be programmed to occur at certain intervals as is known in the art to minimize power consumption. The power is conveniently supplied by batteries and the transmission may occur through a built-in antenna on the printed circuit board.

In a further aspect of the present invention, there is provided an arrangement wherein at least one of the measured parameters is adjusted by a factor to account for location of the sensor. Normally, this meteorological parameter would be the interior temperature as measured by the display unit when the display unit is mounted on a window frame. Thus, as is well known, the temperature proximate a window is substantially lower/higher than the true value within a room depending upon the thermal characteristics of a window and exterior conditions.

The adjustment may be made by several different ways including a predetermined value. For example, if the exterior temperature is at −18° C. and the interior temperature sensed is +15° C., then the interior temperature may be adjusted by a certain amount (for example 5° C.) to account for the thermal characteristics of the window. Naturally, each window would have different characteristics and different adjustment factors would need to be employed.

If desired, the degree of adjustment of the internal temperature may also reflect conditions such as wind speed, solar exposure, and the like. The adjustment may be relatively simple (a certain amount of degrees for each given temperature) or alternatively, various algorithms may be employed. For example, each display unit may have the option of either automatically or manually programming the factor by which the internal temperature display is modified. One could, for example, rely on actual measurements taken by other instruments during a setup period and then program this into the micro-controller such that when similar conditions are encountered, an identical modification to the temperature is performed. Alternatively, the modification factor could be programmed into the micro-controller at the factory based on the thermal characteristics of the window and, if desired, this could even be modified after installation.

In one particular embodiment of the present invention, the display unit may be incorporated in a window frame or other part of a window. Thus, the unit could be built into the window frame and the display of the meteorological parameters could be done using conventional technology such as LCD's although it is possible to display the information on the glass panel of the window.

Communication among different units may be accomplished using available frequency with a typical frequency being 2.5 gigahertz. A number of different channels may be utilized as is known in the art.

### BRIEF DESCRIPTION OF THE DRAWINGS

Having thus generally described the invention, reference will be made to the accompanying drawings wherein:

FIG. 1 is a perspective view of a display monitor according to one embodiment of the present invention;

FIG. 2 is a schematic view illustrating the operation of a system according to one embodiment of the present invention;

FIG. 3 is an electrical schematic of a transmitter unit; and

FIG. 4 is an electrical schematic of a receiver.

### DETAILED DESCRIPTION OF THE INVENTION

Referring initially to FIG. 2, there are illustrated a plurality of sensors 10, 110, 210, each sensor being designed to measure at least one meteorological condition such as temperature, wind speed, humidity, barometric pressure, etc. Each of the sensors in turn emits a wireless signal 12, 112, 212 sending the data.

Interiorly, there are provided a plurality of display monitors 20, 120, 220, each of which is capable of receiving signals 14, 114, 214 from the sensors 10, 110, 210. In turn, each of the display monitors 20, 120, 220 can act as a repeater station and broadcast the signal 16, 116, 216 received. Thus, even if one of the display monitors 20, 120, 220 has not received a signal from the sensors, it will still be able to display the information, having received it from a display monitor which is proximate thereto.

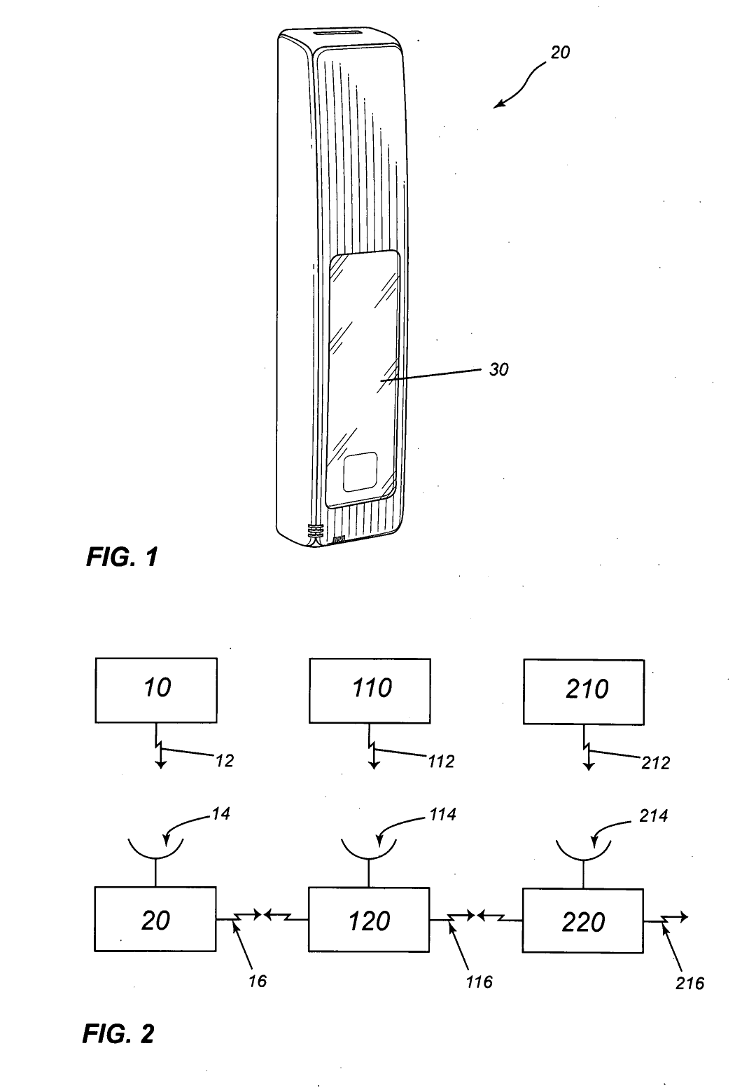

Each of the display monitors 20, 120, 220 is capable of being mounted on a window frame and/or the window itself: A typical display monitor 20 is illustrated in FIG. 1 and includes a display screen 30. In addition to having the capability of displaying the information received (and broadcasting the data) each of the display units preferably will have the capability of modifying the actual internal temperature sensed and displaying such a modified temperature. In this regard, the display monitor could be calibrated for a known heat loss factor and such a program would be useful in the-case of efficient windows with limited thermal loss. This is the most desirable approach though the display monitor could also be programmed for use with older less efficient windows.

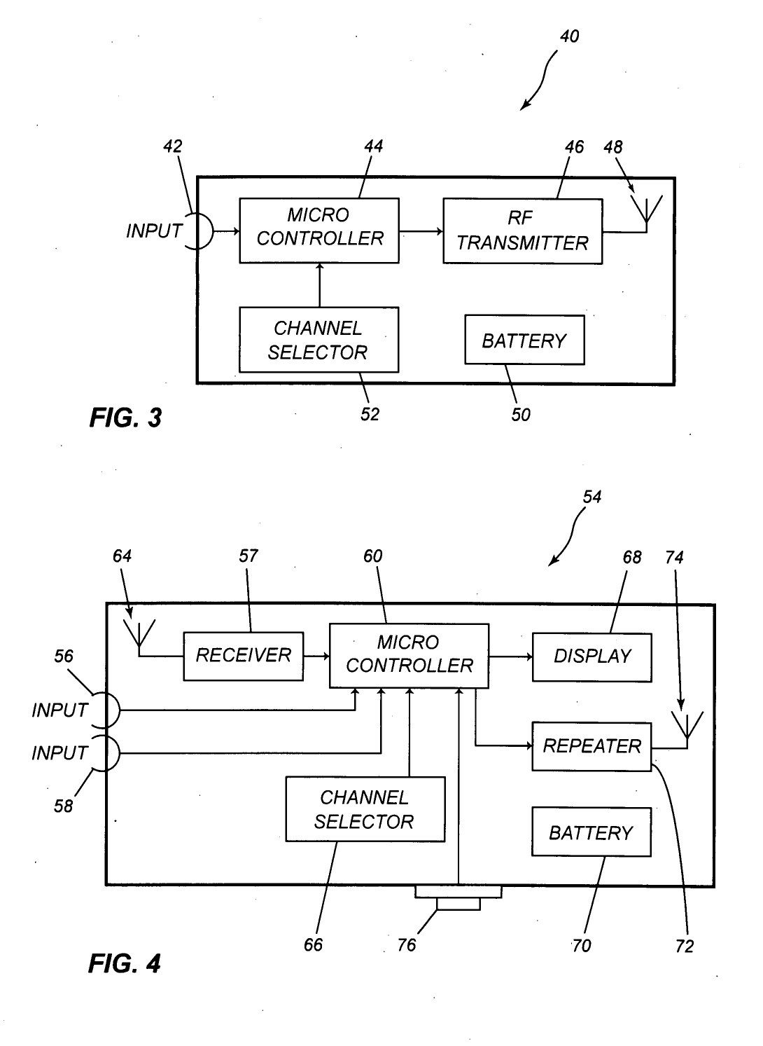

FIG. 3 illustrates a typical transmitter which may be utilized in the practice of the present invention and which transmitter is generally designated by reference numeral 40.

Transmitter 40 is designed to receive an input 42 from a sensor and which is fed to micro-controller 44. A channel selector 52 is associated with micro-controller 44 as is known in the art. A RF transmitter 46 receives output from micro-controller 44 and transmits the data by means of an antenna 148 which, as previously mentioned, can be built right into the circuit board. Power is supplied by battery 50.

Turning to FIG. 4, there is illustrated a display unit generally designated by reference numeral 54. Display unit 54 is designed to receive, in the illustrated embodiment, inputs 56 and 58 which are fed to a micro-controller 60. A receiver 57 having an antenna 64 also provides an input to micro-controller 60. A channel selector 66 is provided to operate on the same channel as selected by channel selector 52 associated with transmitter 40.

A display screen 68 receives the information from micro-controller 60. Information is also passed onto a repeater 72 having an antenna 74. Power is supplied by a battery or batteries 70. An activation button 76 is also provided

It will be understood that the above described embodiments are for purposes of illustration only and changes and modifications may be made thereto without departing from the spirit and scope of the invention.

I claim:

1. A meteorological display system for a building comprising:
at least one sensor designed to be mounted exteriorly of said building to sense at least one meteorological condition;
a transmitter designed to be mounted proximate said sensor, said transmitter having a circuit to transmit a signal of a value measured by said at least one sensor;
a first display unit for mounting interiorly of said building, said first display unit having a circuit for receiving said signal and displaying an indicia reflecting said at least one meteorological condition, a repeater transmitter associated with said first display unit for sending a repeater signal corresponding to said signal from said transmitter;
a second display unit, said second display unit having a circuit for receiving said repeater signal and displaying an indicia reflecting said at least one meteorological condition from said repeater signal.

2. The meteorological display system of claim 1 wherein said at least one sensor senses an exterior temperature.

3. The meteorological display system of claim 2 wherein said first display unit further includes a sensor for sensing and displaying an interior temperature.

4. The meteorological display system of claim 3 wherein said second display unit includes means for sensing and displaying an interior temperature.

5. The meteorological display system of claim 1 comprising a plurality of sensors designed to be mounted exteriorly of said building, each of said sensors measuring a different meteorological condition, and a transmitter associated with each sensor to transmit a signal of a respective value measured by each sensor.

6. A meteorological display system for use with a window comprising:
at least one sensor designed to be mounted exteriorly of said window to sense an exterior temperature;
a transmitter associated with said sensor to send a signal corresponding to a value sensed by said at least one sensor;
a display unit for mounting on said window, said display unit having a sensor for sensing an interior temperature, a receiving circuit for receiving said signal from said exterior sensor;
signal modifying means for modifying said internal temperature signal to display an adjusted value.

7. The meteorological display system of claim 6 wherein said signal modifying means modifies said internal temperature signal according to said exterior temperature.

8. The meteorological display system of claim 7 wherein said signal modifying means for modifying said internal temperature signal also modifies said signal according to thermal characteristics of said window.

9. The meteorological display system of claim 6 wherein said signal modifying means includes manual means to input a temperature variant.

10. A method for displaying meteorological conditions comprising the steps of:
placing at least one sensor exterior of a building to sense at least one exterior meteorological condition;
transmitting a signal corresponding to a value sensed by said sensor;
placing a display unit interiorly of a building, said display unit having a circuit for receiving said signal and displaying an indicia reflecting said at least one meteorological condition;
taking said signal received by said display unit and relaying said signal to at least one further display unit.

11. A method for displaying meteorological conditions comprising the steps of:
sensing an exterior temperature with a sensor located exteriorly of a building;
transmitting a signal reflective of said exterior temperature;
placing a display unit on an interior side of a window, said display unit having an internal sensor to sense and display and interior temperature; and
modifying said interior temperature according to said value of said exterior temperature.
